(19) United States
(12) Patent Application Publication
(10) Pub. No.: US 2005/0091119 A1
(43) Pub. Date: Apr. 28, 2005

(54) Server configuration for printing a digital image product

(76) Inventors: Chris Tuijn, Lier (BE); Marc Gemis, Boom (BE); Eddy Op de Beeck, Hever (BE)

Correspondence Address: Robert A Sabourin;Patent Department, Agfa Corporation, 200 Ballardvale Street, Wilmington, MA, 01069, US

(21) Appl. No.: 10/503,644

(22) PCT Filed: Sep. 2, 2002
(86) PCT No.: PCT/EP02/09888

Related U.S. Application Data
(60) Provisional application No. 60/373,567, filed on Apr. 18, 2002.
(60) Provisional application No. 60/389,692, filed on Jun. 18, 2002.

(30) Foreign Application Priority Data
Feb. 13, 2002 (EP) 02100130.0
Feb. 13, 2002 (EP) 02100129.2

(51) Int. Cl. G06F 17/60

(52) U.S. Cl. 705/26

(57) ABSTRACT

A computer program and system for printing a digital image product that includes an image, the system including: a plurality of servers capable of communicating with each other via a network: a client server for obtaining from a customer a printing order of the digital image product; a main server for receiving the printing order from the client server; a plurality of laboratory servers, each coupled to printing means for printing the digital image product; and a dedicated image server, different from the main server and different from the laboratory servers, and having means for storing the image as digital image data and bringing the image on-line on the network.

### FIELD OF THE INVENTION

The invention relates to the field of printing digital image products via a computer network.

### BACKGROUND OF THE INVENTION

To obtain prints from a roll of exposed photographic film, a customer can take his film roll to a shop that provides a service for film processing and place a printing order. The film roll is then developed and prints are made, either in the shop itself, e.g. by means of a minilab, or at another location such as a large laboratory that uses whole sale finishing (WSF) equipment. The customer can then return to the shop to collect the ordered prints.

If the customer is connected to a computer network such as the Internet, he can also scan his film roll to obtain digital images and send the digital images over the computer network, together with a printing order, to a site that provides a photofinishing service. The digital images may be scanned from a film roll but they may also be obtained directly by means of a digital camera. From the digital images, the ordered prints are made by means of photofinishing equipment (whole sale finishing (WSF) or minilab). Then, the prints are sent directly to the customer by regular mail, or they are sent to a local shop where the customer can collect his prints. Patent application EP-A-0 856 972 discloses a network photograph system that provides a customer with a service related to a photograph via a network such as the Internet. The disclosed network photograph system includes at least one laboratory server installed in a laboratory and a center server installed in a service center. The center server receives a printing order from the customer via the network. The center server selects one of the laboratory servers dependent on the order information. The printing order information is then transmitted from the center server to the selected laboratory server, so that the printing processing can be carried out by the laboratory in which the selected laboratory server is installed. The digital image to be printed is stored by the selected laboratory server or it is stored by the center server and transmitted to the selected laboratory server.

There is still a need for an improved system and method for printing digital images via a network.

### SUMMARY OF THE INVENTION

The present invention is a system for printing a digital image product, as claimed in independent claim 1, and a method for printing a digital image product, as claimed in independent claim 10. Preferably, a method in accordance with the invention is implemented by a set of computer programs as claimed in claim 21. The invention also includes a method for controlling operation of an image server as claimed in independent claim 17, a computer program implementing this method as claimed in claim 23, and an image server as claimed in claim 25. Preferred embodiments of the invention are set out in the dependent claims.

A system in accordance with the invention preferably includes a client server, a main server, one or more image servers and a plurality of laboratory servers, that are capable of communicating data with each other via a computer network such as the Internet. Briefly, the relation between these servers is as follows. A printing order is transmitted from the client server by a customer; the main server acts as a gateway between the client server and the laboratory servers, that take care of the fulfillment of the printing orders; the images involved in the printing order are obtained from one or more dedicated image servers. The functions of these servers are discussed in detail further below, under the “Detailed Description of the Invention”.

A “server” is a component in a network that is used to provide services to one or more other components in the network. In general, such services may include access to files, routing of e-mail, etc. In this document, the services relate directly or indirectly to the printing of images. A server may have an active, i.e. pushing, role, or a passive, polling role. An example of a server with an active role is a main server that sends a printing order to a server at the site of a supplier of digital image products. An example of a server with a passive role is a specific server that polls another server to check whether an order for that specific server has already arrived at the other server. The functions of a server, i.e. to provide the services mentioned above, can be implemented by means of a computer program running on a hardware device. It is customary to call this computer program a “server”, and to use the term “server” also for the hardware device on which the computer program, that provides the services, is running or is to be run. Thus, a “server” can mean the hardware associated with it, the associated software, the associated hardware including the software; what is meant can be determined in each specific case from the context. In this document, a “server” may also be a cluster of hardware devices acting as a single server on the network. Such a cluster is perceived as a single server by the other servers on the network.

That a first server is “different” from a second server means in this document that the hardware device associated with the first server is different from the hardware device associated with the second server.

In this document, “transmitting” data from a first server to a second one includes the case wherein the first server has an active role and the case wherein the second server has a passive, polling role; it also includes the case wherein the data are transmitted from the first to the second server via one or more intermediate servers. All these cases are also included if a server “receives” data from another one.

“Bringing an image on-line” or bringing it “on-line on a network” means making the image (i.e. the image data) available to all servers on the network.

A “digital image product” may be a simple print of a digital image or it may involve the printing of digital images, such as a T-shirt or a mug bearing a print of a digital image. A digital image product may include one or more digital images; an example of the latter is a calendar with a digital image for the cover and twelve other digital images, one per month.

Preferably, in a system in accordance with the invention one or more dedicated image servers are used, that are different from the main server and different from the laboratory servers. An advantage of such a system is its flexibility. Advantageously, all printing order related data and communications are handled by the main server (also called eCommerce server), while all image data communications are handled by the image server(s). Thus, both the main server and the image server(s) have a “central” function; they provide services (e.g. the communications mentioned above) to the “decentralized” client servers and laboratory servers. Preferably, the data used by the main server do not contain actual image data but instead contain an “image reference”, such as a Uniform Resource Locator (URL), to the image data, and the image data are stored on an image server. An advantage of a system in accordance with the invention is that the hardware of a particular server may be specifically tailored to the functions of that particular server. Thus, the main server does not have to be provided with huge disk storage capacities to store the image data. In a preferred embodiment, the main server does not have means, such as a storage device and the appropriate software, for storing images as digital image data and for bringing the images on-line on the network. Possibly, an image is temporarily stored by the main server, e.g. when transmitting the image from one server to another one via the main server. This does not require storage means with a large capacity, nor does it require software to bring the image on-line. Instead, it is preferred that the image server(s) have these means for storing images as digital image data and bringing the images on-line on the network. Thus, an image server advantageously has huge image storage capabilities to store image data that may originate from a very large number of customers.

Another advantage of a system in accordance with the invention is its flexibility with respect to the number of main servers and image servers, and with respect to their relationship. Multiple main servers and/or multiple image servers may be used, and a one-to-one correspondence between main servers and image servers is not required. Preferably, a printing order is only submitted to one main server; if multiple main servers are available, they typically each manage different sets of storefronts. A “storefront” displays a products list to the customer, that can be used to make printing orders; for more information on storefronts, and also for other relevant terms, we refer to patent application EP 02100129.2 filed on 13 Feb. 2002. Different main servers can use and share multiple image servers; a one-to-one correspondence between main servers and image servers is not required. Moreover, within one main server setup, several physical machines may be set up in a cluster, so that the combination of the different hardware machines acts as a single main server to the outside world. Analogously, several image servers may be set up in a cluster. An advantage of a system that uses multiple main servers and/or multiple image servers, possibly set up in a cluster, is that redundancy and scalability may be provided. In fact, a technical breakdown, such as a hardware problem, will have a much smaller effect on such a system. Moreover, if the main server(s) are getting overloaded, this can e.g. be solved by adding an additional main server, without modifying the image server capacity, and vice versa.

As mentioned above, a system in accordance with the invention may comprise means for storing an image reference, such as a URL, to the image data. Image references may be stored by the main server. In a particular embodiment of the invention, a dedicated database server stores the image references and makes them available to the main server.

It is preferred that a laboratory server regularly polls another server—such as the main server—to check if a printing order for that laboratory server is waiting to be fulfilled. The laboratory server then downloads its waiting printing orders in order to fulfill them. An advantage of having the laboratory servers polling for their printing orders is that they need not be permanently on-line on the network. They can e.g. be on-line only outside of peak hours on the Internet, when data transfer is faster and therefore cheaper.

Preferred embodiments of a system in accordance with the invention may include features of a method—as claimed or as described above or below—in accordance with the invention.

Further advantages and embodiments of the present invention will become apparent from the following description and drawings.

### BRIEF DESCRIPTION OF THE DRAWINGS

The invention is described with reference to the following drawings without the intention to limit the invention thereto, and in which:

FIG. 1 shows a diagram of an embodiment of a system in accordance with the invention;

FIG. 2 shows a different type of diagram of another embodiment of a system in accordance with the invention.

### DETAILED DESCRIPTION OF THE INVENTION

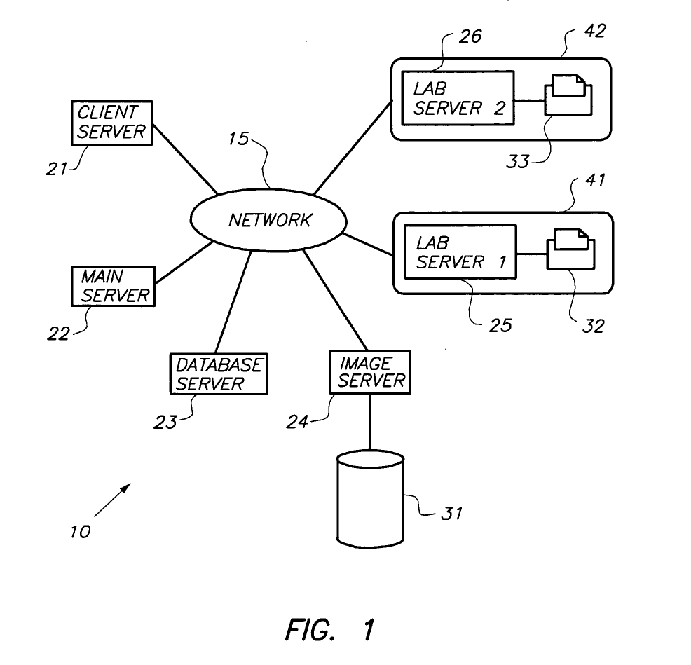

FIG. 1 shows an embodiment of a system 10 in accordance with the invention. The functions of the different servers 21-26 in such a system 10 are as follows.

A customer orders printing of a digital image product at a client server 21. The system 10 may include a very large number of client servers 21, that may run on different types of hardware. A client server 21 may run on the customer's computer, on a Personal Digital Assistant (PDA), on a kiosk system, on a mobile telephone, etc. In a preferred embodiment, the client server 21 retrieves a storefront from the main server 22, out of a set of storefronts that are managed by the main server 22. The client server then retrieves for a specific storefront the digital image products and the corresponding prices that are supported by that storefront, so that the customer can select the product(s) he wants to order. In case multiple main servers 22 are available, they typically each manage different sets of storefronts. One main server 22 may then act as coordinating main server 22: when the customer selects a specific storefront, he can retrieve from the coordinating main server 22 which main server 22 manages that specific storefront. For all subsequent calls, the customer then contacts that main server 22 directly, either automatically and invisible to the customer, or by a selection action of that main server 22 by the customer.

The printing order is then transmitted from the client server 21 to the main server 22 via the network 15. The printing order may be stored by the main server 22. In another embodiment of the invention, the system 10 comprises a database server 23 and the printing order is stored by the database server 23. The database server 23 and the main server 22 may run on the same hardware. However, it is preferred that a dedicated database server 23 is used, coupled to the main server 22, e.g. via the network 15, and running on separate hardware for better performance. Since the database server 23 is in a certain sense the core of the system 10, it is preferably clustered internally. In this way, redundancy is built in in case of hardware or software failures. Advantageously, both software components (such as software relating to retrieve/insert/update server process) and hardware components (storage arrays) are duplicated.

The printing order for one or more digital image products may contain image references to images involved in the product(s); the printing order may also directly include involved images, preferably as digital image data.

The images may come from different sources. In the most typical case, the images are stored locally at a client server 21 (on the hard disk of the customer's computer, on the hard disk of the kiosk system, on the storage medium of the PDA or mobile telephone, etc.). The images are then uploaded from the client server 21 to an image server 24, while image references to the images, preferably URL's, are stored by the main server 22 or by the database server 23. In a preferred embodiment, the image references of images to be printed are stored in an order database of the main server 22, or, if present, of the database server 23. In a second case, the images are on-line at another server, e.g. a third party image server (such as a web album). Image references are used during the definition of the printing order and, as in the first case, they are stored by the main server 22 or by the database server 23. Actually, the image references may point to images residing on an image server 24 or on any other server connected to the network 15. Thumbnails of the images may be generated and sent to the client server. In a third case, the images result from scanning film rolls at a laboratory 41, 42; the high-resolution images are then typically stored at a laboratory server 25, 26 in the laboratory 41, 42, and low-resolution thumbnail representations are available from an image server 24. In a fourth case, images that were uploaded previously to an image server 24 are reordered by the customer. For reordering, the images will not be uploaded again if they are still present at an image server 24.

An image server 24 has means for receiving images from client servers 21 via the network 15 and means, such as a storage device 31 and the appropriate software, for storing the images as digital image data and for bringing the images on-line on the network 15. The image server may have huge disk storage capacities 31 to store image data that may originate from a very large number of customers. Preferably, the image server 24 also has means for generating low-resolution thumbnail representations from the high-resolution images, and for storing the low resolution image data. Such a capability of the image server 24 to generate and store thumbnails is particularly useful when fast access is required to browse through a set of images, e.g. in order to allow a customer to make an interactive selection of images. It is then not necessary to download the high-resolution images; instead, the low-resolution thumbnail images may be sent to the client server 21.

The image servers 24 may manage their own file system and may also take care of the removal of images. It is preferred that the uploader of images defines how long the images should be kept on the image servers 24. An expiration date is then associated with a stored image and the image servers 24 have means for checking whether the expiration date of an image has elapsed. If this is the case, the concerned image server 24 makes the image inaccessible from the network 15 and preferably removes the corresponding digital image data. If a customer reorders an image that was uploaded previously to an image server 24, it will be checked if the image is still on-line on the network 15. If the image is still on-line, the image will be retrieved from the image server 24 so that it can be reprinted. To retrieve an image, it is preferred that an encoded image reference to the image is used, as follows. When uploading the image to the image server 24, preferably a fixed static URL is used. However, the image server 24 retrieves the image with another URL that can be used to retrieve that specific image in the future. This other URL is somewhat encoded, in order to avoid unwanted access to the image in the future. This encoded URL should be kept for future retrieval of the image. In retrieving the image, it is checked if the used image reference is the specific encoded image reference associated with the image; if this is the case, the image is retrieved, otherwise a message is returned that retrieval of the image is not allowed.

To fulfill a printing order, the order has to be transmitted to a laboratory server 25, 26. A plurality of laboratory servers 25, 26 are connected to the network 15; each laboratory server 25, 26 is located in a laboratory 41, 42 where the actual printing can be carried out. A printing order is only transmitted to a selected laboratory server, in the laboratory where the printing order will be fulfilled. The laboratory server may be selected by the customer when he defines the printing order. Alternatively, the laboratory server may be selected automatically, preferably by the main server, and based on data of the printing order (e.g. the selected laboratory server should be located in a laboratory where the ordered digital image product, e.g. a T-shirt, can be printed; preferably, the laboratory is located in the neighborhood of the customer, etc.). As mentioned already above, it is preferred that a laboratory server 25, 26 regularly polls another server—such as the main server 22—to check if a printing order for that laboratory server 25, 26 is waiting to be fulfilled. The laboratory server 25, 26 then downloads its waiting printing orders in order to fulfill them. Preferably, the downloaded printing orders are stored in a local database for efficiency. Usually the printing orders as received by the laboratory servers 25, 26 contain image references to the images involved in the digital image products that are to be printed. By using the image references, the laboratory servers 25, 26 obtain the involved images, typically from an image server 24 over the network 15, or from another source, even directly in the laboratory 41, 42 itself, if the image reference indicates so. Each laboratory server 25, 26 is coupled to printing means 32, 33 for printing digital image products.

After printing, the digital image products are sent to the customer, e.g. by regular mail, or they are made available for pick-up at a particular place. This is described in detail in patent application EP 02100129.2 filed on 13 Feb. 2002, mentioned above.

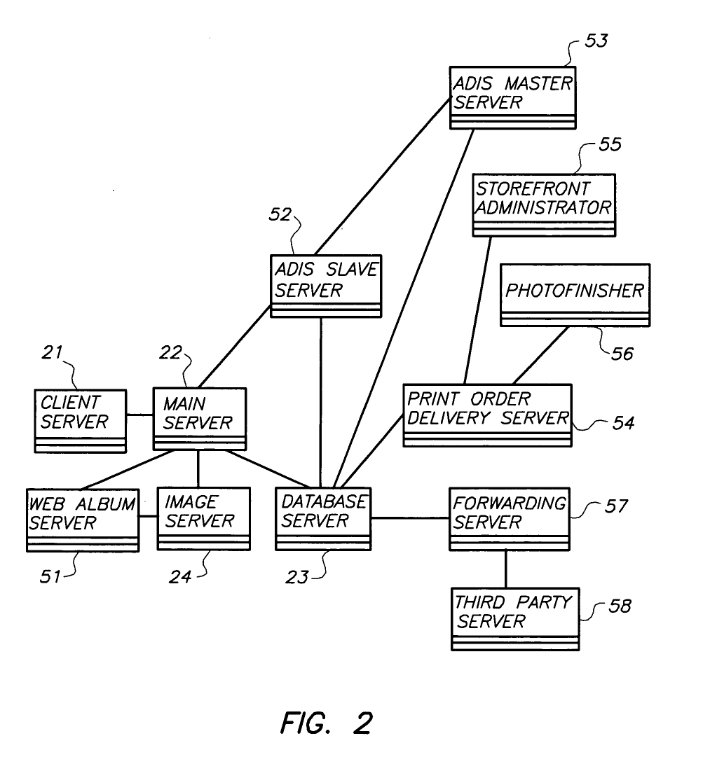

FIG. 2 shows another embodiment of a system in accordance with the invention, represented by a different type of diagram: whereas FIG. 1 shows a rather physical picture of the network 15 and the servers 21-26 in an embodiment of a system in accordance with the invention, FIG. 2 is a rather logical representation, showing the interdependencies between the servers in another embodiment of a system in accordance with the invention.

FIG. 2 shows a client server 21, a main server 22, a database server 23 and an image server 24, that are also present in the embodiments illustrated by FIG. 1 and that are likewise connected to a computer network (which is not indicated by a reference sign in FIG. 2). Except when indicated otherwise, these servers 21-24 have the same features and functions in the embodiments disclosed below, with reference to FIG. 2, as in the embodiments discussed above, with reference to FIG. 1. In addition to FIG. 1, FIG. 2 shows the following components.

The photofinisher node 56 in FIG. 2 corresponds to a laboratory server 25, 26 as shown in FIG. 1. A system according to the invention includes a plurality of photofinisher nodes 56; only one photofinisher node 56 is shown in FIG. 2. The photofinisher nodes 56 poll the print order delivery server 54 at regular times to check whether new printing orders have arrived. Multiple print order delivery servers 54 may be present. The print order delivery servers 54 get the printing orders from a database server 23. Preferably, each print order delivery server 54 is only served by one database server 23. Multiple print order delivery servers 54 may run on the same database server 23. The printing orders are stored by the database server 23, preferably in an order database.

Analogously to a print order delivery server 54, a forwarding server 57 receives printing orders from the database server 23. Preferably, this occurs by polling: the forwarding server 57 polls the database server 23 for printing orders that have been submitted to storefronts that are managed by “foreign” print servers, i.e. third party servers 58 that may be part of another computer network, of a third party. The forwarding server 57 then submits the printing orders to the third party servers 58 (and communicates with the third party servers 58 over the “third party protocol”). Contrary to the print order delivery server scenario, the storefronts of the forwarding server 57 are managed at the third party server 58 associated with the forwarding server 57, and the photofinishers retrieve the orders by means of third party software from the third party server 58.

The storefront administrator 55 is responsible for the storefront administration. The storefront administration can be done remotely. It includes defining the products and the associated prices, selecting the traffic channels a particular storefront will support, providing the advertising information that will be made available to the customers, administering the promotion codes, etc. We refer to patent application EP 02100129.2 filed on 13 Feb. 2002 and mentioned already above, for more information on storefront administration, which is called “storefront management” in that application.

The web album server 51 takes care of managing web albums. On the one hand, conventional film rolls may be scanned in a laboratory and the resulting digital images stored in web albums. On the other hand, customers may store their digital images on-line in web albums, possibly third party albums. In both cases, the web album server 51 manages these albums. Preferably, the web albums are consulted through an XML-based protocol (XML stands for extensible Markup Language) and the user interface for web albums is implemented on another server or stand-alone client application. In a preferred embodiment, the role of the web album server 51 in the system is as follows. The web album server 51 stores basic albums that include images. These images are stored on image servers 24. The albums are owned by customers; the data relating to these customers are stored on a main server 22. In FIG. 2, the complete web album system is represented by a single web album server 51. However, the functionality of such a web album system may be implemented by an entire subsystem that includes a plurality of servers.

From the ADIS master server 53 (ADIS stands for Agfa Digital Imaging Service), all storefronts are accessible. This server maintains at all times an updated list of the storefronts, a kind of “directory” of all storefronts.

Each ADIS slave server 52 maintains a group of storefronts that belong to a specific organization or group of organizations (such as large photofinishing companies).

In a preferred embodiment, storefronts are created and updated as follows. Storefront creation is always carried out on the ADIS master server 53. Once the storefronts are created, they are replicated on the ADIS slave server 52 that manages the storefront. The storefront administration of a specific storefront is always carried out on the managing ADIS slave server 52. In case of updates to the storefront, this information is replicated immediately on the main server 22.

Except for the ADIS master server 53, which is unique, the system may include a plurality of all other components shown in FIG. 2.

Those skilled in the art will appreciate that numerous modifications and variations may be made to the embodiments disclosed above without departing from the scope of the present invention.

List of Reference Signs

10 network system
15: network
21 client server
22: main server
23: database server
24: image server
25 laboratory server
26: laboratory server
31: storage means
32: printing means
33: printing means
41 laboratory
42 laboratory
51 web album server
52: ADIS slave server
53: ADIS master server
54: print order delivery server
55: storefront administrator
56: photofinisher
57: forwarding server
58 third party server.

1. A network system for printing a digital image product comprising an image, the system comprising:
a client server for obtaining from a customer a printing order of said digital image product;
a main server for receiving said printing order from said client server via a network;
an image server, different from said main server, and having means for storing said image as digital image data and bringing said image on-line on the network;
a plurality of laboratory servers, wherein each of said laboratory servers:
i) is different from said image server;
ii) is installed in a laboratory;
iii) has means for receiving said printing order from said main server via the network;
iv) has means for receiving said digital image data from said image server via the network; and
v) is coupled to printing means for printing said digital image product.

2. The system according to claim 1 wherein said main server has no means for storing said image as digital image data and bringing said image on-line on the network.

3. The system according to claim 1 further comprising means for storing an image reference to said image.

4. The system according to claim 3 wherein said main server comprises said means for storing said image reference.

5. The system according to claim 3 further comprising a database server coupled to said main server and having said means for storing said image reference.

6. The system according to claim 1 wherein said digital image data are high resolution image data and wherein said image server further has means for generating and storing low resolution image data of said image, said low resolution image data having a lower amount of data than that of said high resolution data.

7. The system according to claim 1 wherein said main server is a cluster of devices acting as a single server on the network.

8. The system according to claim 1 wherein said image server is a cluster of devices acting as a single server on the network.

9. The system according to claim 1 wherein said means of said laboratory servers for receiving said printing order are polling means.

10. A method for printing a digital image product via a network, said digital image product comprising an image, the method comprising the steps of:
obtaining a printing order for printing said digital image product from a customer at a client server;
transmitting said printing order from said client server to a main server via the network;
storing said image as digital image data by an image server, different from said main server and connected to the network;
bringing said image on-line on the network by said image server;
selecting a laboratory server out of a plurality of laboratory servers, wherein each of said laboratory servers is different from said image server, is installed in a laboratory and is coupled to a printer for printing said digital image product;
transmitting said printing order from said main server to said selected laboratory server via the network;
transmitting said digital image data from said image server to said selected laboratory server via the network; and
printing said digital image product by said printer coupled to said selected laboratory server.

11. The method according to claim 10 wherein said step of selecting said laboratory server is performed by said main server, based on said printing order, or by said customer.

12. The method according to claim 10 further comprising the step of:
storing an image reference to said image by said main server or by a database server coupled to said main server via the network.

13. The method according to claim 12 further comprising the step of:
storing said printing order by said main server or by said database server.

14. The method according to claim 10 further comprising the steps of:
checking whether said image is still on-line on the network or not;
if said image is still on-line, retrieving said digital image data from said image server and transmitting said digital image data from said image server to said selected laboratory server via the network; and
reprinting said digital image product by said printer coupled to said selected laboratory server.

15. The method according to claim 14 further comprising the step of:
using an encoded image reference to said image in said retrieving said digital image data from said image server.

16. The method according to claim 10 further comprising the step of:
polling said main server by said selected laboratory server to check whether said printing order is present at said main server.

17. A method for controlling operation of an image server in a network, the method comprising the steps of:
receiving an image via the network from a client server at a customer;
storing said image as digital image data;
bringing said image on-line on the network; and
transmitting said image via the network to a selected laboratory server out of a plurality of laboratory servers, wherein each of said laboratory servers is installed in a laboratory.

18. The method according to claim 17 further comprising the following steps performed by said image server:
checking if an image reference used for retrieving said image is a specific encoded image reference associated with said image; and
if said image reference is said specific encoded image reference, retrieving said image, else returning a message that retrieval of said image is not allowed.

19. The method according to claim 17 further comprising the following steps performed by said image server:
checking whether an expiration date of said image has elapsed; and
if said expiration date has elapsed, making said image inaccessible from the network and removing said digital image data.

20. The method according to claim 17 wherein said digital image data are high resolution image data, the method further comprising the following steps performed by said image server:
generating low resolution image data of said image, said low resolution image data having a lower amount of data than that of said high resolution data; and
storing said low resolution image data.

21. (canceled)

22. (canceled)

23. (canceled)

24. (canceled)

25. (canceled)

26. The method according to claim 10 further comprising the following steps performed by said image server:
checking whether an expiration date of said image has elapsed; and
if said expiration date has elapsed, making said image inaccessible from the network and removing said digital image data.

27. The method according to claim 10 wherein said digital image data are high resolution image data, the method further comprising the following steps performed by said image server:
generating low resolution image data of said image, said low resolution image data having a lower amount of data than that of said high resolution data; and
storing said low resolution image data.
